(19) United States
(12) Patent Application Publication
(10) Pub. No.: US 2024/0154141 A1
(43) Pub. Date: May 9, 2024

(54) PLUG-IN FUEL CELL MODULE

(71) Applicant: Ruben G. Creus, Ashburn, VA (US)

(72) Inventor: Ruben G. Creus, Ashburn, VA (US)

(21) Appl. No.: 18/501,723

(22) Filed: Nov. 3, 2023

Related U.S. Application Data
(60) Provisional application No. 63/382,140, filed on Nov. 3, 2022.

(51) Int. Cl. H01M 8/04992; B60L 50/75; H01M 10/0525; H01M 10/34; H01M 10/44; H01M 16/00

(52) U.S. Cl. CPC H01M 8/04992; B60L 50/75; H01M 10/0525; H01M 10/345; H01M 10/441; H01M 16/006; H01M 2220/20; H01M 2250/20; H01M 2250/402

(57) ABSTRACT

A plug-in fuel cell module (PFCM) has software with artificial intelligence algorithms. The PFCM is a module that generally connects to both conventional hydrogen fuel cells and to associated rechargeable batteries. Battery usage trends are recorded and artificial intelligence algorithms inside the PFCM are then used to predict the optimal time frames to activate the hydrogen fuel cell (HFC) and recharge said batteries—subsequently extending their life and maximizing their performance. For example, an electric vehicle (EV) equipped with a hydrogen tank, a HFC, and a PFCM allows users to drive for longer distances and eliminate long recharging times normally associated with EVs.

### CROSS-REFERENCE TO RELATED APPLICATION

This application claims the benefit of priority of U.S. provisional application No. 63/382,140, filed Nov. 3, 2022, the contents of which are herein incorporated by reference.

### BACKGROUND OF THE INVENTION

The present invention relates to hydrogen fuel cells (HFCs) and, more particularly, to a module that connects to HFCs and rechargeable batteries to extend their life and performance.

During the early 1950s, Alan Turing (a young British mathematician) was one of the first researchers to explore the mathematical possibility of artificial intelligence (AI). Turing suggested that humans use available information as well as reason in order to solve problems and make decisions and wondered why computers could not do the same. Research was slow. During this time, computers lacked a key prerequisite for intelligence: they couldn't store commands—they could only execute them. In addition, the cost of leasing a computer to conduct such research cost ˜$200,000 a month and only prestigious universities and big technology companies could afford them. Five years later, a logic program was designed to mimic the problem-solving skills of humans and was funded by the RAND Corporation. This program is considered by many to be the first artificial intelligence program and was presented at the Dartmouth Summer Research Project on Artificial Intelligence. In the 1970s, computers could store more information and became faster, cheaper, and more accessible. Machine learning algorithms also improved, and people got better at knowing which algorithm to apply to specific problems. However, weaknesses continued. The biggest problem was the lack of computational power to do anything substantial: computers simply couldn't store enough information or process it fast enough. In order to communicate, for example, one needs to know the meanings of many words and understand them in many combinations and the computing power was not ready.

In the 1980's, interest in AI was reignited by two sources: an expansion of the algorithmic toolkit, and a boost in private funding. During these years, researchers popularized ‘deep learning’ techniques which allowed computers to learn using experience data. ‘Expert systems’ which mimicked the decision-making process of a human expert also emerged. This program would ask an expert in a field how to respond in a given situation, and once this was learned for virtually every situation, non-experts could receive advice from that program. Expert systems were widely used in industries. In 1997, reigning world chess champion and grandmaster Gary Kasparov was defeated by IBM®'s Deep Blue, a chess playing computer program. This highly publicized match was the first time a reigning world chess champion lost to a computer and served as a huge step towards an artificially intelligent decision-making program. In the same year, speech recognition software, developed by Dragon Systems, was implemented on Windows® computers. This was another great step forward in the direction of the spoken language interpretation endeavor. Kismet, a robot developed by Cynthia Breazeal was an AI system that recognized and displayed human emotions.

2015 was considered to be a landmark year for artificial intelligence as the number of software projects, such as ‘AI Google’ and ‘neural networks’, became available. These increases in affordable neural networks were due to a rise in cloud computing infrastructure and to an increase in research tools and datasets. Other examples of popular AI include Microsoft™'s development of a Skype® system that automatically translates from one language to another and Facebook™'s system that can describe images to blind people. Around 2016, China greatly accelerated its government funding (given its large supply of data and its rapidly increasing research output); some observers believe it may be on track to becoming an ‘AI superpower.’

Currently available electric vehicles (EV) provide low range and long recharge time, discouraging consumers from purchasing them.

While AI has been gaining popularity in many industrialized nations, only a few researchers have started leveraging AI for use in HFCs and rechargeable batteries. United States Publication No. US2006/0138996 disclosed a module to transfer an electric charge from a HFC to backup batteries. Patent No. U.S. Ser. No. 10/599,106 disclosed a cloud-based AI system to control a battery device. Patent No. U.S. Ser. No. 11/131,713 disclosed an AI system for predicting the lifespan of a battery. Patent No. U.S. Ser. No. 11/065,978 and Publication No. US2020/0011932 disclosed AI systems for optimizing battery performance. The disclosures of US Patents U.S. Ser. No. 10/599,106, U.S. Ser. No. 11/131,713, and U.S. Ser. No. 11/065,978 and US Publications US2006/0138996 and US2020/0011932 are incorporated by reference in their entireties.

None of the prior art suggests recharging EV batteries while the motor is running, much less analyzing energy use to determine when to recharge the batteries.

As can be seen, there is a need for a system that leverages AI to enhance battery life while using HFCs in conjunction with said batteries.

### SUMMARY OF THE INVENTION

The device herein disclosed and described provides a solution to the shortcomings in the prior art through the disclosure of a PFCM with artificial intelligence software algorithms.

An object of the invention is to contribute to zero emission, alternative energy enhancements. The PFCM works with HFCs to recharge batteries (such as those commonly utilized in vehicles and facility backup generators) that currently run on fossil fuels. Extending the life of rechargeable batteries in vehicles and generators can contribute to overall reductions in carbon emissions (also referred to as ‘decarbonizing’).

Another object of the invention is to provide a means to leverage AI to extend battery life with HFC in the most efficient manner possible. Battery manufacturers recommend minimum battery charge levels to maximize battery life. The PFCM's AI learns energy consumption trends over time and predicts when the minimum level will be reached, it then activates the HFC in advance of the event to prevent the battery from entering a charge state below its minimum recommended level. Conversely, early activations would translate into an unnecessary and inefficient waste of HFC resources.

Another object of the invention is to provide complimentary technologies to curb emissions and attract wide-spread consumer adoption. The HFC's quick refueling process makes up for the slow recharge time of batteries. It also provides for extended battery life—which, in the case of the EV example, can translate into greater mileage and extended travel distances.

Another object of the invention is to allow users to monitor and customize all PFCM operations on their mobile devices. For example, a school facility manager can view a HFC's contribution to backup generator batteries and manually over-ride AI predictions for HFC activations during a storm forecast to ensure early activation and ensure continuance of service (despite the small sacrifice of an efficiency loss).

In one aspect of the present invention, a plug-in fuel cell module comprises a battery connection interface for coupling with rechargeable batteries; a hydrogen fuel cell connection interface for coupling with conventional hydrogen fuel cells; an onboard firmware module containing artificial intelligence algorithms; a current sensor operative to sense energy levels of the rechargeable batteries in real-time; an onboard buffer memory for storing battery usage trends, the onboard buffer memory being electronically coupled to the onboard firmware module; a current switch unit for controlling power flow, the current switch unit being electronically coupled to the onboard firmware module; a CAN bus communications module for data exchange; and an external charging port.

In another aspect of the present invention, a method for extending the life and maximizing the performance of rechargeable batteries, comprises providing the plug-in, fuel cell module; recording the battery usage trends; analyzing the battery usage trends using the artificial intelligence algorithms in the onboard firmware; predicting optimal activation times for a hydrogen fuel cell based on the analyzed battery usage trends; and activating the hydrogen fuel cell to recharge the batteries when the predicted optimal activation times are reached.

These and other features, aspects and advantages of the present invention will become better understood with reference to the following drawings, description, and claims.

### BRIEF DESCRIPTION OF THE DRAWINGS

The accompanying drawings, which are incorporated herein and form a part of the specification, illustrate some, but not the only or exclusive, examples of embodiments and/or features.

FIG. 1 is a schematic view of a system according to an embodiment of the present invention;

FIG. 2 is another schematic view thereof;

FIG. 3 is another schematic view thereof;

FIG. 4 is another schematic view thereof; and

FIG. 5 is a flow chart of a method according to an embodiment of the present invention.

Other aspects of the present invention shall be more readily understood when considered in conjunction with the accompanying drawings, and the following detailed description, neither of which should be considered limiting.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

It is briefly noted that upon reading this disclosure, those skilled in the art will recognize various means for carrying out these intended features of the invention. As such it is to be understood that other methods, applications, and systems adapted to the task may be configured to carry out these features and are therefore considered to be within the scope and intent of the present invention and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods, and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether they affect the activity or action of the listed elements. The objects, features, and advantages of the present invention, as well as the advantages thereof over existing prior art, which will become apparent from the description to follow, are accomplished by the improvements described in this specification and hereinafter described in the following detailed description which fully discloses the invention but should not be considered as placing limitations thereon.

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

Broadly, one embodiment of the present invention is a PFCM with artificial intelligence software algorithms that analyze battery usage trends to predict optimal recharging intervals and activate a hydrogen fuel cell (HFC) to recharge the batteries during the predicted intervals.

The PFCM may connect to various external components, including but not limited to a conventional rechargeable battery pack (e.g., lithium ion, nickel hydride, etc.), a conventional HFC, and a conventional electric motor. Said external components may be part of a larger system including, but not limited to, an EV, backup generator for a facility, and the like.

Internal PFCM components may include, but are not limited to, amperage detection such as a current sensor providing real time sensing of battery energy levels; onboard buffer memory; and firmware. The firmware is stored onboard on a readable, non-transitory storage media comprising software that is operable when executed by another onboard controller or server.

In some embodiments, the present invention comprises an electric vehicle comprising a battery array, an electric motor, an AI-driven PFCM and a HFC recharge system.

A method of using the module includes but is not limited to the following steps: activating the PFCM upon start up, detecting battery usage trends and storing the trends into the onboard buffer memory; analyzing the battery usage trends with AI algorithms and predicting optimal times to activate HFC to recharge batteries.

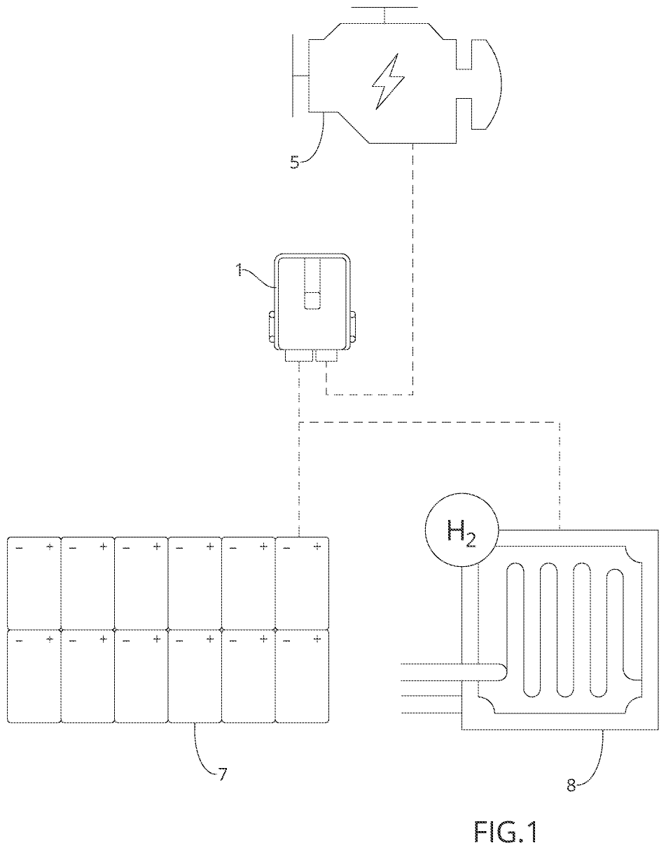

Referring to FIGS. 1 through 5, FIG. 1 shows a plug-in fuel cell module (PFCM) 1 connected to a rechargeable battery pack 7 powering an electric motor 5 and a hydrogen fuel cell (HFC) 8 operative to recharge the battery pack 7.

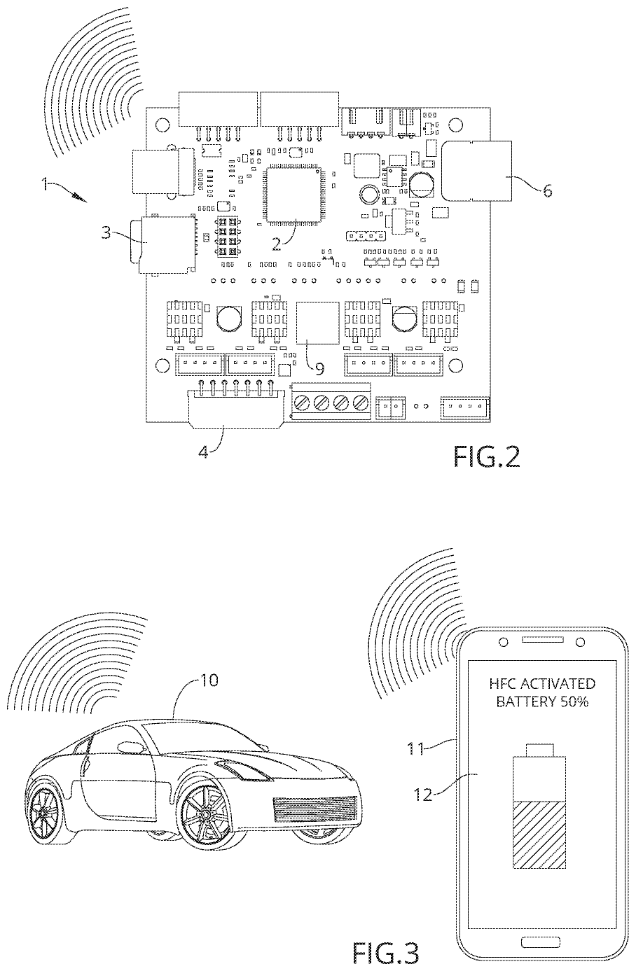

FIG. 2 shows said PFCM 1 comprising an artificial intelligence module 2 with onboard buffer memory; a current sensor 3; an external charging port 4; a CAN bus communications module 6; and a current switch unit 9. The AI module 2 contains algorithms that read battery sensor levels and activate the HFC 8 when said AI algorithms predict a recharge is needed.

FIG. 3 shows an embodiment wherein a user with a vehicle 10 has access to a mobile device application 12 on a smart phone 11 that indicates PFCM 1 activities in real time using wireless communications such as, but not limited to, Bluetooth® short-wave wireless communication methods, etc.

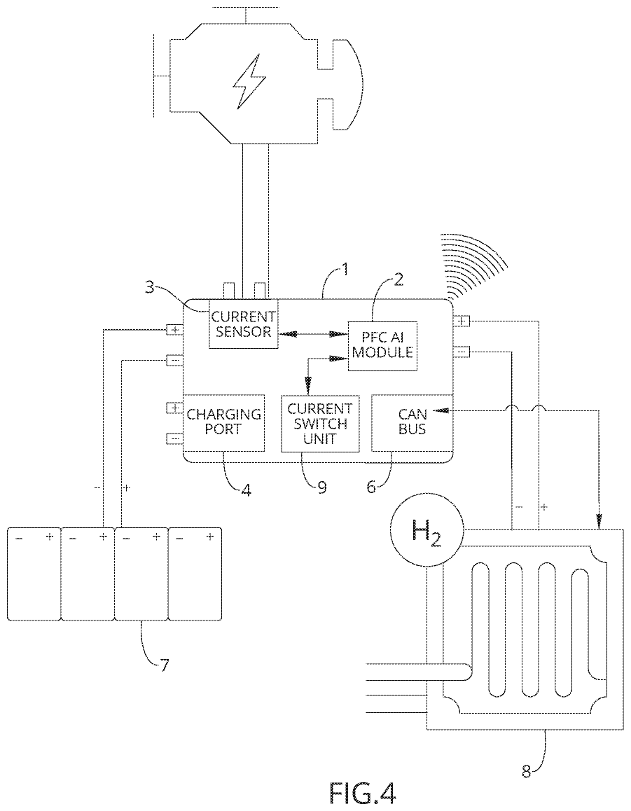

FIG. 4 illustrates a system according to an embodiment of the present invention, wherein the PFCM 1 senses current draw from the motor 5 by way of the current sensor 3 and analyzes the data with the AI module 2, which is operative to activate a current switch unit 9 when criteria are met to recharge the battery array 7 with the hydrogen fuel cell 8, both of which electronically communicate with the module 1. As illustrated in FIG. 3, the module 1 has a wireless communications module operative to interact with the user's app 12. The module 1 communicates with the HFC 8 by way of a Controller Area Network (CAN) bus module 6.

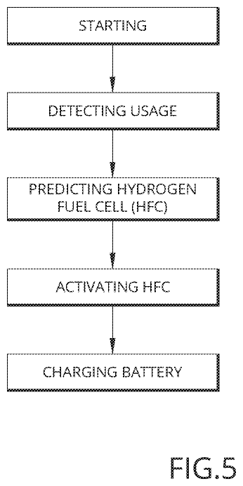

FIG. 5 shows a method of using the module 1 that includes activating the PFCM upon start up, detecting battery usage trends, predicting optimal times to activate the HFC 8 to recharge the batteries 7, and charging the batteries 7 with the HFC 8.

It is additionally noted and anticipated that although the device is shown in its most simple form, various components and aspects of the device may be differently shaped or slightly modified when forming the invention herein. As such, those skilled in the art will appreciate the descriptions and depictions set forth in this disclosure are merely meant to portray examples of preferred modes within the overall scope and intent of the invention and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth.

It should be understood, of course, that the foregoing relates to exemplary embodiments of the invention and that modifications may be made without departing from the spirit and scope of the invention as set forth in the following claims.

What is claimed is:

1. A plug-in fuel cell module comprising:
a) a battery connection interface for coupling with rechargeable batteries;
b) a hydrogen fuel cell connection interface for coupling with conventional hydrogen fuel cells;
c) an onboard firmware module containing artificial intelligence algorithms;
d) a current sensor operative to sense energy levels of the rechargeable batteries in real-time;
e) an onboard buffer memory for storing battery usage trends, the onboard buffer memory being electronically coupled to the onboard firmware module;
f) a current switch unit for controlling power flow, the current switch unit being electronically coupled to the onboard firmware module;
g) a Controller Area Network bus communications module for data exchange; and
h) an external charging port.

2. The plug-in fuel cell module of claim 1, wherein the onboard firmware module is operable to:
a) analyze battery usage trends stored in the onboard buffer memory;
b) predict optimal activation times for the hydrogen fuel cell based on the analyzed battery usage trends; and
c) activate the hydrogen fuel cell to recharge the batteries when predicted optimal activation times are reached.

3. The plug-in fuel cell module of claim 1, wherein the firmware containing artificial intelligence algorithms is stored on a readable, non-transitory storage media and is operable when executed by another onboard controller or server.

4. The plug-in fuel cell module of claim 1, wherein the plug-in, fuel cell module is configured to connect to external components, selected from the group consisting of a lithium-ion battery pack, nickel-hydride battery pack, an electric motor, and any combination thereof.

5. The plug-in fuel cell module of claim 1, further comprising a mobile device application for enabling users to monitor and customize plug-in, fuel cell module operations in real-time using wireless communications.

6. The plug-in fuel cell module of claim 5, wherein the wireless communications include short-range wireless communication methods.

7. The plug-in fuel cell module of claim 1, wherein the plug-in, fuel cell module is utilized in an electric vehicle equipped with a hydrogen tank, a hydrogen fuel cell and said plug-in, fuel cell module to extend driving range and reduce recharging times.

8. A method for extending the life and maximizing the performance of rechargeable batteries, comprising:
a) providing the plug-in, fuel cell module of claim 1;
b) recording the battery usage trends;
c) analyzing the battery usage trends using the artificial intelligence algorithms in the onboard firmware;
d) predicting optimal activation times for a hydrogen fuel cell based on the analyzed battery usage trends; and
e) activating the hydrogen fuel cell to recharge the batteries when the predicted optimal activation times are reached.

9. The method of claim 8, wherein the onboard firmware with artificial intelligence algorithms is stored on a readable, non-transitory storage media and is operable when executed by another onboard controller or server.

10. The method of claim 8, further comprising enabling users to monitor and customize plug-in, fuel cell module operations in real-time using wireless communications through a mobile device application.
